(19) United States
(12) Patent Application Publication
(10) Pub. No.: US 2025/0157691 A1
(43) Pub. Date: May 15, 2025

(54) WIRE HARNESS ARRANGEMENT STRUCTURE

(71) Applicant: YAZAKI CORPORATION, Tokyo (JP)

(72) Inventors: Junya KATO, Shizuoka (JP); Taku FURUTA, Shizuoka (JP)

(73) Assignee: YAZAKI CORPORATION, Tokyo (JP)

(21) Appl. No.: 18/944,248

(22) Filed: Nov. 12, 2024

(30) Foreign Application Priority Data
Nov. 13, 2023 (JP) 2023-192700

(51) Int. Cl. H01B 7/00; B60R 16/02

(52) U.S. Cl. CPC H01B 7/0045; B60R 16/0215

(57) ABSTRACT

A wire harness arrangement structure includes a wire harness having an electric wire group and a pair of connectors and a fixing member on which the wire harness is arranged. The pair of the connectors have a pair of first connectors and a pair of second connectors; the electric wire group has a first electric wire group including a plurality of first electric wires and a second electric wire group including a plurality of second electric wires; the first electric wire group has a first sheath for covering an outer circumference of the plurality of the first electric wires, and is arranged on the fixing member via the first sheath; and the second electric wire group has a second sheath for covering an outer circumference of the plurality of the second electric wires, and is arranged on the fixing member via the second sheath.

### CROSS-REFERENCE TO RELATED APPLICATIONS

The present application is based on, and claims priority from the prior Japanese Patent Application No. 2023-192700, filed on Nov. 13, 2023, the entire contents of which are incorporated herein by reference.

### TECHNICAL FIELD

The present disclosure relates to a wire harness arrangement structure.

### BACKGROUND

JPH08205356A discloses technology related to a wire harness arrangement structure. Conventionally, a wire harness arrangement structure includes a wire harness having an electric wire group including a plurality of electric wires and a plurality of pairs of connectors electrically connected to both ends of the electric wire group. Another known wire harness arrangement structure includes a vehicle body as a fixing member on which the wire harness is arranged (see JPH08205356A). The electric wire group of the wire harness includes a trunk line and a plurality of branch lines branched from the trunk line. First side ends of the trunk line and the plurality of branch lines are electrically connected to a plurality of first connectors. Second side ends of the plurality of branch lines are electrically connected to a plurality of second connectors. In this wire harness arrangement structure, the trunk line is fixed to a plurality of protectors, thereby maintaining the arrangement form of the trunk line with respect to the vehicle body. The plurality of branch lines are drawn out from the protectors and arranged between adjacent protectors.

### SUMMARY OF THE INVENTION

In such a wire harness arrangement structure as described in JPH08205356A, a plurality of branch lines are branched from the trunk line in which the arrangement form with respect to the fixing member is fixed based on the trunk line. Therefore, the arrangement form of the branch wires with respect to the fixing member is determined by the trunk line, and there is no degree of freedom in the arrangement form of the branch wires with respect to the fixing member. If there is no degree of freedom in the arrangement form of the branch wires, it is required to unnecessarily increase the length of the electric wires with respect to the pair of connectors whose arrangement positions are determined, thereby increasing the cost.

The present disclosure has been made in view of such problems of the conventional technology. It is an object of the present disclosure to provide a wire harness arrangement structure capable of providing a degree of freedom in the arrangement form of the electric wire group and reducing the cost.

A wire harness arrangement structure according to the embodiment includes a wire harness having a wire group including a plurality of electric wires and a plurality of pairs of connectors electrically connected to both ends of the electric wire group; a fixing member on which the wire harness is arranged, in which the pairs of the connectors have at least a pair of first connectors and a pair of second connectors; the electric wire group has a first electric wire group including a plurality of first electric wires electrically connected at both ends to the pair of the first connectors, and a second wire group including a plurality of second electric wires electrically connected at both ends to the pair of the second connectors; the first electric wire group has a first sheath for bundling the plurality of the first electric wires and covering an outer circumference of the plurality of the first electric wires, and is arranged on the fixing member via the first sheath; and the second wire group has a second sheath for bundling the plurality of the second electric wires and covering an outer circumference of the plurality of the second electric wires, and is arranged on the fixing member via the second sheath.

According to the present disclosure, it is possible to provide a wire harness arrangement structure capable of providing a degree of freedom to the arrangement form of the electric wire group and reducing the cost.

### BRIEF DESCRIPTION OF DRAWINGS

FIG. 1 is a schematic view of a wire harness arrangement structure according to the embodiment.

FIG. 2 is a schematic view of connectors and electric wire groups in the wire harness arrangement structure according to the embodiment.

FIG. 3 is an enlarged perspective view of an essential part of a first electric wire group in the wire harness arrangement structure according to the embodiment.

FIG. 4 is an enlarged perspective view of an essential part illustrating another example of the electric wire group in the wire harness arrangement structure according to the embodiment.

FIG. 5 is an enlarged perspective view of an essential part illustrating another example of the electric wire group in the wire harness arrangement structure according to the embodiment.

FIG. 6 is an enlarged side view of an essential part when a first terminal is attached to a first electric wire in the wire harness arrangement structure according to the embodiment.

FIG. 7 is a perspective view of a first housing of a first connector in the wire harness arrangement structure according to the embodiment.

FIG. 8 is an enlarged front view of an essential part when the electric wire group is attached to a fixing part of the wire harness arrangement structure according to the embodiment.

FIG. 9 is an enlarged front view of an essential part when the electric wire is attached to a fixing part of the wire harness arrangement structure according to the embodiment.

### DETAILED DESCRIPTION OF THE INVENTION

Hereinafter, the wire harness arrangement structure according to the embodiment will be described in detail with reference to the drawings. Note that the dimensional ratios in the drawings are exaggerated for the sake of explanation and may differ from the actual ratios.

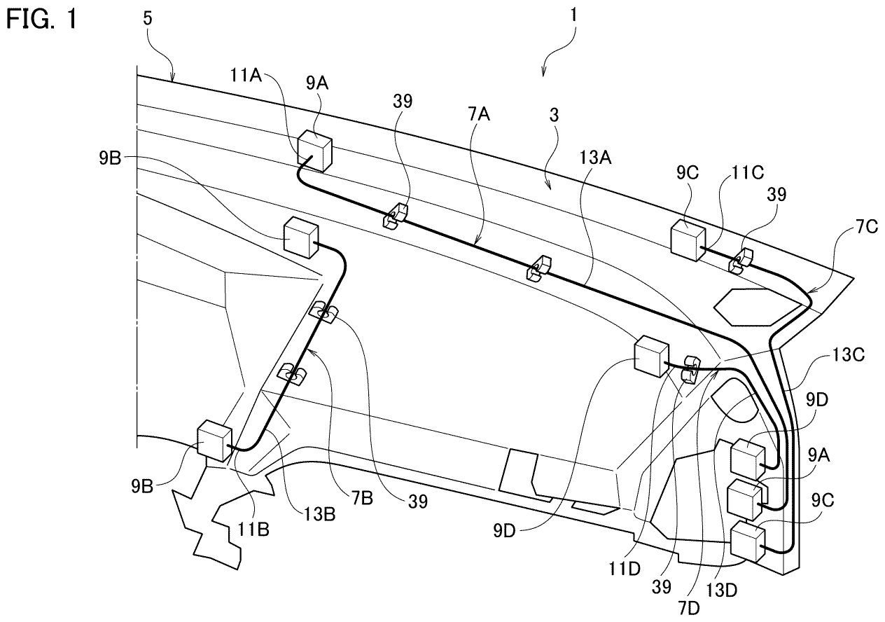

As illustrated in FIG. 1, the wire harness arrangement structure 1 according to the embodiment is applied to a wire harness 3 for electrically connecting electrical components (not illustrated) between a power supply mounted on a vehicle and an apparatus, or between apparatuses. The wire harness 3 is arranged in a predetermined arrangement form with respect to a fixing member 5 such as a body or a panel of a vehicle.

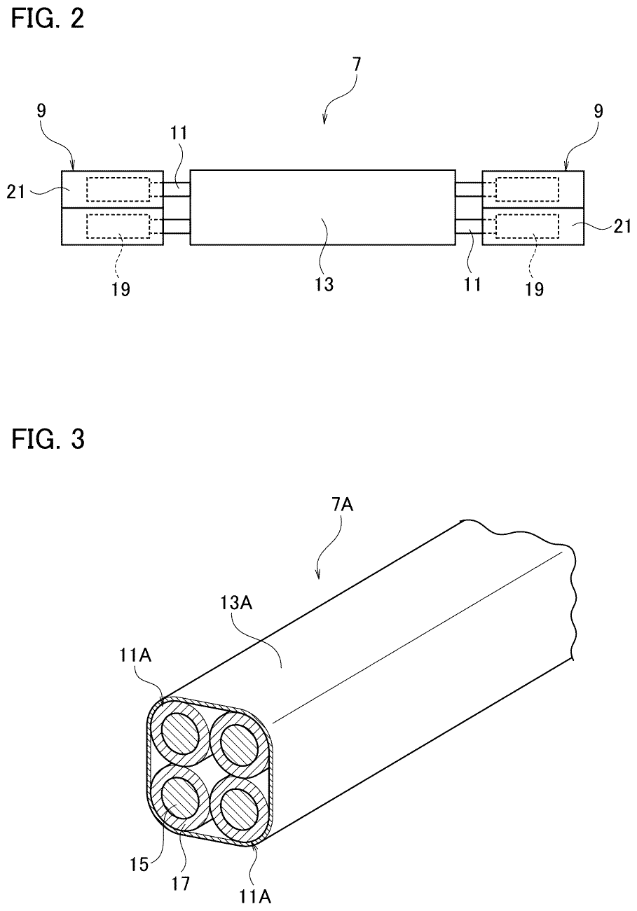

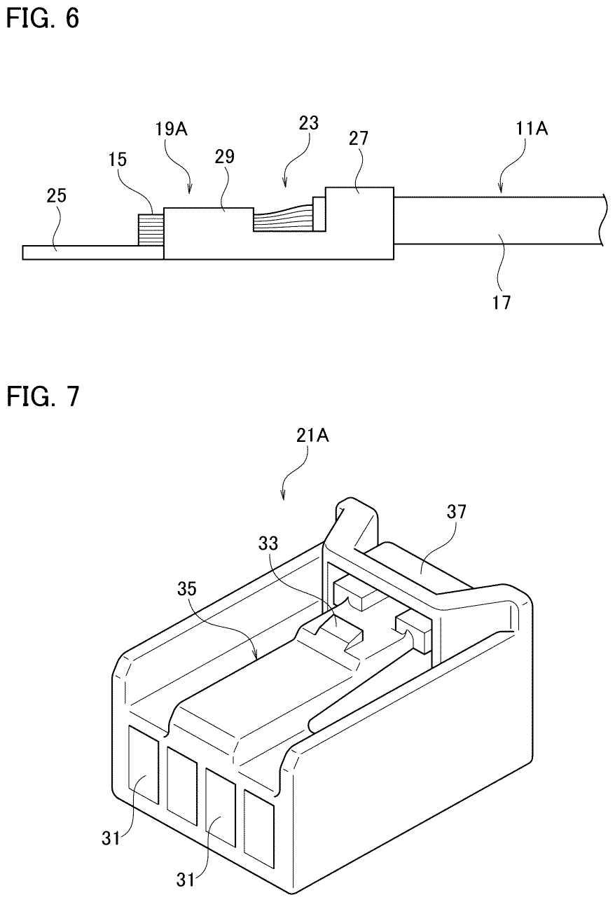

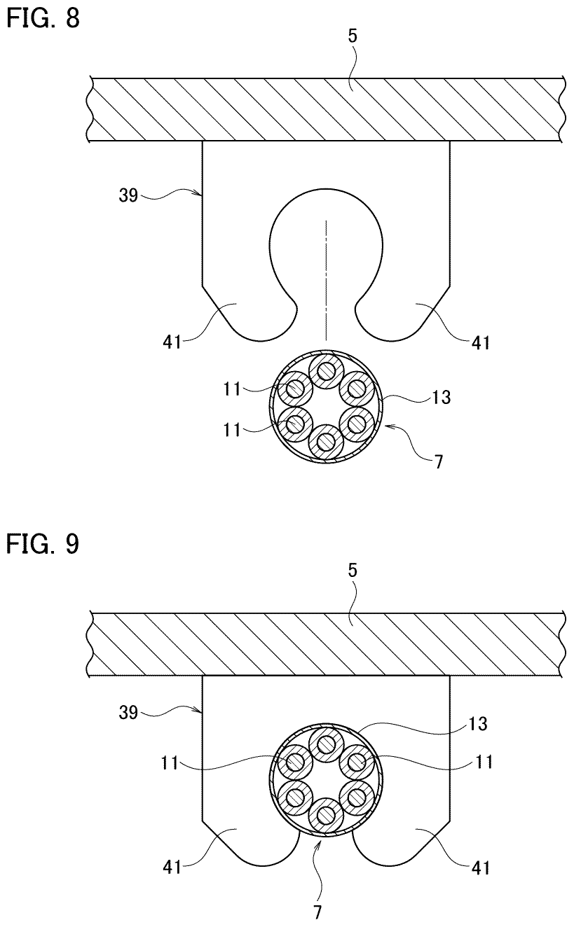

As illustrated in FIGS. 1 to 9, the wire harness arrangement structure 1 includes the wire harness 3 and the fixing member 5.

As illustrated in FIGS. 1 to 7, the wire harness 3 includes electric wire groups 7 and connectors 9.

The electric wire group 7 includes a plurality of electric wires 11. A plurality (here, 4) of the electric wire groups 7 are provided as the electric wire groups 7, corresponding to electric components to be electrically connected. Here, the electric wire group 7 includes a first electric wire group 7A, a second electric wire group 7B, a third electric wire group 7C, and a fourth electric wire group 7D. Since the basic configurations of the plurality of electric wire groups 7 are similar, the first electric wire group 7A will be mainly described below, and the other electric wire groups 7 will not be described in detail.

As illustrated in FIGS. 1 to 5, the first electric wire group 7A includes a plurality of first electric wires 11A and a first sheath 13A.

The first electric wires 11A include, for example, covered electric wires in which an outer circumference of a core wire 15 made of a conductive material is covered with an insulating coating 17 made of an insulating material. The plurality of the first electric wires 11A (here, 4) having different types of signal wires and power supply wires, different sizes of wire diameters, or the like are used in accordance with a circuit of electric components to be applied. Both ends of the first electric wires 11A are electrically connected to two electric components, thereby electrically connecting the two electric components.

The first sheath 13A is made of an insulating material such as vinyl chloride or polyethylene. The first sheath 13A covers an outer circumference of the plurality of the first electric wires 11A with the plurality of the first electric wires 11A bundled together. The plurality of the first electric wires 11A are bundled and covered with the first sheath 13A, so that the first electric wire group 7A can be treated as one electric wire. In addition, the plurality of the first electric wires 11A can be protected. The first electric wire group 7A in which the plurality of the first electric wires 11A are bundled with the first sheath 13A is also referred to as a cabtyre cable.

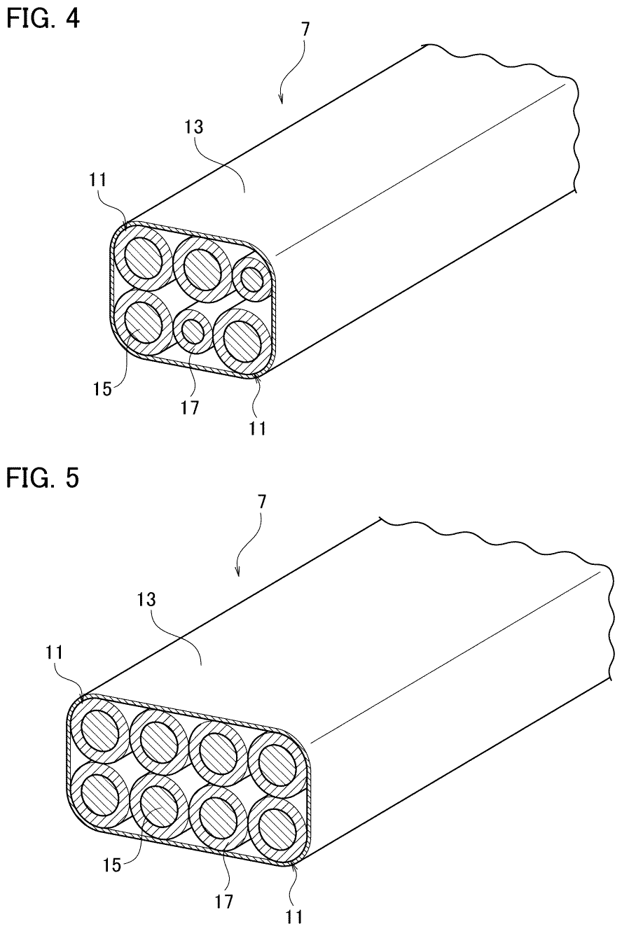

The plurality of the electric wire groups 7 may have any number of the electric wires 11 in each of the electric wire groups 7. For example, as illustrated in FIG. 4, the number of the electric wires 11 may be six, and an outer circumference of the six electric wires 11 bundled together may be covered with a sheath 13 to form one of the electric wire groups 7. Alternatively, as illustrated in FIG. 5, the number of the electric wires 11 may be eight, and an outer circumference of the eight electric wires 11 bundled together may be covered with the sheath 13 to form one of the electric wire groups 7.

The connectors 9 are provided at both ends of the plurality of the electric wire groups 7, and a pair of the connectors 9 is used for each of electric wire groups 7. For this reason, four pairs of the connectors 9, that is a pair of first connectors 9A and 9A, a pair of second connectors 9B and 9B, a pair of third connectors 9C and 9C, and a pair of fourth connectors 9D and 9D corresponding to the four electric wire groups 7 are used. Since the basic configurations of the plurality of connectors 9 are similar, the first connectors 9A will be mainly described below, and detailed descriptions of the other connectors 9 will be omitted.

As illustrated in FIGS. 1, 2, 6, and 7, the first connector 9A includes a plurality of first terminals 19A and a first housings 21A.

The plurality (here, 8) of the first terminals 19A are used, corresponding to both ends of the plurality (here, 4) of the first electric wires 11A. The first terminals 19A are made of a conductive material, and includes, for example, an electric wire connecting portion 23 and an electrical connecting portion 25. The electric wire connecting portion 23 has a covering and fixing portion 27, and a core wire fixing portion 29. The covering and fixing portion 27 has a pair of swaging pieces, and the first terminals 19A are fixed to the first electric wires 11A by swaging the pair of swaging pieces with respect an outer circumference of the insulating coating 17 of the first electric wires 11A. The core wire fixing portion 29 has a pair of crimping pieces, and the first terminals 19A and the first electric wires 11A are electrically connected by swaging and crimping the pair of crimping pieces with respect to the outer circumference of the core wire 15 exposed from the insulating coating 17 of the first electric wires 11A. The electrical connecting portion 25 is a member continuous with the electric wire connecting portion 23 and formed in a tab shape. The electrical connecting portion 25 is brought into contact with a mating terminal (not illustrated) of a mating connector (not illustrated) provided on an electric component, thereby electrically connecting the first terminals 19A and the mating terminal.

A pair of the first housings 21A is used, corresponding to both ends of the first electric wire group 7A. The first housings 21A are made of an insulating material such as a synthetic resin, for example, and is formed as a housing that can be fitted with a mating housing (not illustrated) of a mating connector provided on an electric component. The first housings 21A are provided with a plurality (here, 4) of terminal reception chambers 31 capable of receiving the first terminals 19A corresponding to a plurality (here, 4) of first terminals 19A provided on one side end of the first electric wire group 7A. By receiving the plurality of the first terminals 19A in the plurality of the terminal reception chambers 31, ends of the first electric wires 11A (here, 4) are bundled in the first connectors 9A. A lock arm 35 having a lock portion 33 is provided on an upper portion of the first housings 21A. The lock arm 35 is elastically deformable and can be engaged with a locked portion (not illustrated) provided on mating housings. The lock portion 33 of the lock arm 35 is engaged with the locked portion, thereby maintaining a fitting state between the first housings 21A and the mating housings. The engagement between the lock portion 33 and the locked portion is released by elastically deforming the lock arm 35 by pressing the operation part 37 of the lock arm 35, thereby releasing the engagement between the first housings 21A and the mating housings. When the first housings 21A are engaged with the mating housings, the first terminals 19A and the mating terminals are electrically connected.

As illustrated in FIG. 1, the wire harness 3 as described above is arranged on the fixing member 5 such as a vehicle body or panel. The wire harness 3 arranged on the fixing member 5 needs to be fixed in an arrangement form relative to the fixing member 5 in order to avoid interference with peripheral members or to improve appearance, for example. Therefore, the fixing member 5 is provided with fixing parts 39.

As illustrated in FIGS. 1, 8, and 9, the fixing parts 39 are provided integrally with the fixing member 5 and has a pair of clamping portions 41, 41 opened on an opposite side of the fixing member 5. When the sheath 13 of the electric wire groups 7 is inserted through the opening, the pair of the clamping portions 41, 41 hold the electric wire groups 7 by clamping the outer circumference of the sheath 13 like a clamp or clip, and fix the electric wire groups 7 to the fixing member 5. The fixing member 5A is provided with a plurality (here, 6) of the fixing parts 39. The fixing member 5 is provided with the plurality of the fixing parts 39 so that at least one of the fixing parts 39 corresponds to one of the electric wire groups 7. Here, the first electric wire group 7A is provided with two fixing parts 39, and the first sheath 13A for bundling and covering the plurality of the first electric wires 11A is fixed to the fixing parts 39. The second electric wire group 7B is provided with two fixing parts 39, and the second sheath 13B for bundling and covering the plurality of second electric wires 11B is fixed to the fixing parts 39. The third electric wire group 7C is provided with one fixing part 39, and a third sheath 13C for bundling and covering a plurality of third electric wires 11C is fixed to the fixing part 39. The fourth electric wire group 7D is provided with one fixing part 39, and a fourth sheath 13D for bundling and covering a plurality of the fourth electric wires 11D is fixed to the fixing part 39.

In the conventional wire harness arrangement structure, the electric wire groups 7 of the wire harness 3 have a trunk line and a branch line branched from the trunk line. In the conventional wire harness arrangement structure, for example, it is assumed that the trunk line has the arrangement form of the first electric wire group 7A in the wire harness arrangement structure 1. In this case, for example, the second electric wire group 7B, which is a branch line, is required to pass an arrangement path of the first electric wire group 7A, and it is not possible to obtain a shortest arrangement form. Therefore, in the conventional wire harness arrangement structure, there is no degree of freedom in the arrangement form of the electric wire groups 7, and it is required to unnecessarily increase the length of the electric wires 11, which increases the cost. In addition, in the conventional wire harness arrangement structure, a bundling member for bundling a plurality of the electric wires 11, a fixing member that fixes the plurality of electric wires to the fixing member 5, a protection member such as a protector, or the like are assembled in the trunk line and the branch lines, which increases the number of components and the cost.

On the other hand, in the wire harness 3 of the wire harness arrangement structure 1, each of the electric wire groups 7 including the electric wires 11 are electrically connected at both ends to a pair of the connectors 9, 9, and an outer circumference of the electric wires 11 is bundled and covered with the sheath 13. By bundling the plurality of electric wires and covering the outer circumference of the plurality of electric wires 11 with the sheath 13, each of the electric wire groups 7 can be treated as a single electric wire. Therefore, a degree of freedom can be given to the arrangement form of each of the electric wire groups 7, and each of the electric wire groups 7 can be arranged in the shortest route with respect to the fixing member 5. In addition, it is not required to unnecessarily increase the length of the electric wires 11, and the cost can be reduced. Further, the fixing member 5 is provided with the fixing parts 39 for fixing the sheath 13, so that each of the electric wire groups 7 can be fixed to the fixing member 5 by fixing the sheath 13 to the fixing parts 39, and the arrangement form of each of the electric wire groups 7 with respect to the fixing member 5 can be maintained. Therefore, it is not necessary to assemble a bundling member, a fixing member, a protection member, or the like for the plurality of the electric wire groups 7, whereby the number of parts and assembling work can be reduced, and the cost can be reduced.

The wire harness arrangement structure 1 includes the wire harness 3 having the electric wire group 7 including a plurality of the electric wires 11, a plurality of pairs of connectors 9, 9 electrically connected to both ends of the electric wire group 7, and a fixing member 5 on which the wire harness 3 is arranged. The plurality of pairs of connectors 9, 9 have at least a pair of the first connectors 9A, 9A and a pair of the second connectors 9B, 9B. Further, the electric wire group 7 has a first electric wire group 7A including a plurality of the first electric wires 11A electrically connected at both ends to the pair of the first connectors 9A, 9A, and the second electric wire group 7B including a plurality of the second electric wires 11B electrically connected at both ends to the pair of second connectors 9B, 9B. The first electric wire group 7A has a first sheath 13A for bundling the plurality of first electric wires 11A and covering an outer circumference of the plurality of the first electric wires 11A, and is arranged on the fixing member 5 via the first sheath 13A. The second electric wire group 7B has a second sheath 13B for bundling the plurality of the second electric wires 11B and covering an outer circumference of the plurality of the second electric wires 11B, and is arranged on the fixing member 5 via the second sheath 13B.

In each of the electric wire groups 7, by bundling and covering the plurality of the electric wires 11 with the sheath 13, each of the electric wire groups 7 can be treated as one electric wire. Therefore, a degree of freedom can be given to the arrangement form of each of the electric wire groups 7, and each of the electric wire groups 7 can be arranged on the shortest route with respect to the fixing member 5. In addition, it is not required to unnecessarily increase the length of the electric wires 11, and the cost can be reduced.

Therefore, in the wire harness arrangement structure 1, a degree of freedom can be given to the arrangement form of the electric wire group 7, and the cost can be reduced.

Further, the fixing member 5 is provided with the fixing parts 39 for fixing each of the first sheath 13A and the second sheath 13B.

Therefore, by fixing the sheath 13 to the fixing parts 39, each of the electric wire groups 7 can be fixed to the fixing member 5, and the arrangement form of each of the electric wire groups 7 with respect to the fixing member 5 can be maintained. Therefore, it is not necessary to install a bundling member, a fixing member, a protecting member, or the like to a plurality of the electric wire groups 7, whereby the number of components and the assembly work can be reduced, and the cost can be reduced.

Although the embodiment is described above, the embodiment is not limited thereto, and various modifications can be made within the scope of the gist of the embodiment.

For example, in the wire harness arrangement structure according to the embodiment, the number of pairs of connectors is four, but the arrangement is not limited thereto, and the number of pairs of connectors may be three or less, or five or more. In accordance with this arrangement, the number of the electric wire groups may correspond to the number of the pairs of connectors.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A wire harness arrangement structure comprising:
a wire harness having an electric wire group comprising a plurality of electric wires and a plurality of pairs of connectors electrically connected to both ends of the electric wire group; and
a fixing member on which the wire harness is arranged, wherein
the pairs of the connectors have at least a pair of first connectors and a pair of second connectors;
the electric wire group has a first electric wire group comprising a plurality of first electric wires electrically connected at both ends to the pair of the first connectors, and a second electric wire group comprising a plurality of second electric wires electrically connected at both ends to the pair of the second connectors;
the first electric wire group has a first sheath for bundling the plurality of the first electric wires and covering an outer circumference of the plurality of the first electric wires, and is arranged on the fixing member via the first sheath; and
the second electric wire group has a second sheath for bundling the plurality of the second electric wires and covering an outer circumference of the plurality of the second electric wires, and is arranged on the fixing member via the second sheath.

2. The wire harness arrangement structure according to claim 1, wherein the fixing member is provided with fixing parts for fixing each of the first sheath and the second sheath.
